(19) United States
(12) Patent Application Publication
(10) Pub. No.: US 2007/0238332 A1
(43) Pub. Date: Oct. 11, 2007

(54) Electrical connector and its manufacturing method

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/399,353

(22) Filed: Apr. 7, 2006

(51) Int. Cl. H01R 13/44

(52) U.S. Cl. 439/131

(57) ABSTRACT

A manufacturing method for an electrical connector is disclosed, comprising the following steps: an insulating body having an elastic block is provided and conductive material is applied on the elastic block to form a conductive layer. Furthermore, the present invention provides an electrical connector, comprising: an insulating body; at least an elastic block provided on one side of the insulating body to contact with an connected electronic device; at least a through hole provided on one side of the elastic block; and a conductive layer provided on the elastic block. Compared with contemporary technique, the electrical connector according to the present invention has the advantages of simple frame and easy manufacturing as well as achieves effective contact between the electrical connector and its connected electronic devices, leading to low manufacturing cost.

### FIELD OF THE INVENTION

The present invention relates to an electrical connector and its manufacturing method and more particular, to an electrical connector in which the insulating body having at least an elastic block applied with conductive material to form a conductive layer and its manufacturing method.

### BACKGROUND OF THE INVENTION

At present, an electrical connector usually comprises an insulating main body and electrical terminals accommodated inside the insulating main body. The insulating main body is provided with terminal-receiving grooves to receive electrical terminals therein. The electrical terminal is provided with a fixed portion and two contact portions on both ends, wherein compressive contact is made to achieve electrical conduction between two connected electronic devices. However, the electrical terminal is usually made of conductive material; the shape is complicated and the manufacturing method is difficult, leading to high cost. Also, plastic deformation occurs after several rounds of compression, resulting in ineffective contact between the electrical connector and its connected electronic devices.

Consequently, it is necessary to design a new electrical connector and its manufacturing method to overcome the drawbacks described above.

### SUMMARY OF THE INVENTION

An object of the present invention is to provide a manufacturing method for the electrical connector, in which the insulating body having at least an elastic block which is applied with conductive material to form a conductive layer, such that the conductive layer can achieve effective contact between the electrical connector and its connected electronic devices, leading to low manufacturing cost.

Another object of the present invention is to provide an electrical connector, which can achieve effective contact between the electrical connector and its connected electronic devices, leading to low manufacturing cost.

In order to accomplish the aforementioned objects, the present invention provides a manufacturing method, comprising the following steps: an insulating body having an elastic block is provided and conductive material is applied on the elastic block to form a conductive layer.

In order to accomplish the aforementioned objects, the present invention provides an electrical connector, comprising: an insulating body; at least an elastic block provided on one side of the insulating body to contact with a connected electronic device; at least a through hole provided on one side of the elastic block; and a conductive layer provided on the elastic block.

Compared with contemporary technique, the electrical connector and its manufacturing method according to the present invention have the advantages of simple frame and easy manufacturing as well as achieves effective contact between the electrical connector and its connected electronic devices, leading to low manufacturing cost.

### BRIEF DESCRIPTION OF THE DRAWINGS

The present invention can be more fully understood by reference to the following description and accompanying drawings, in which:

FIG. 1 is schematic illustration of the manufacturing method for electrical connector according to the present invention;

FIG. 2 is a cross-sectional view of the insulating body in FIG. 1;

FIG. 3 is a partial enlargement of the insulating body in FIG. 2;

FIG. 4 is a cross-sectional view of the electrical connector according to the present invention;

FIG. 5 is an assembly view of the electrical connector in FIG. 4 according to the present invention and its connected electronic devices;

FIG. 6 is a cross-sectional view of another embodiment of the electrical connector according to the present invention; and

FIG. 7 is an assembly view of the electrical connector in FIG. 6 according to the present invention and its connected electronic devices.

### DETAILED DESCRIPTION OF THE INVENTION

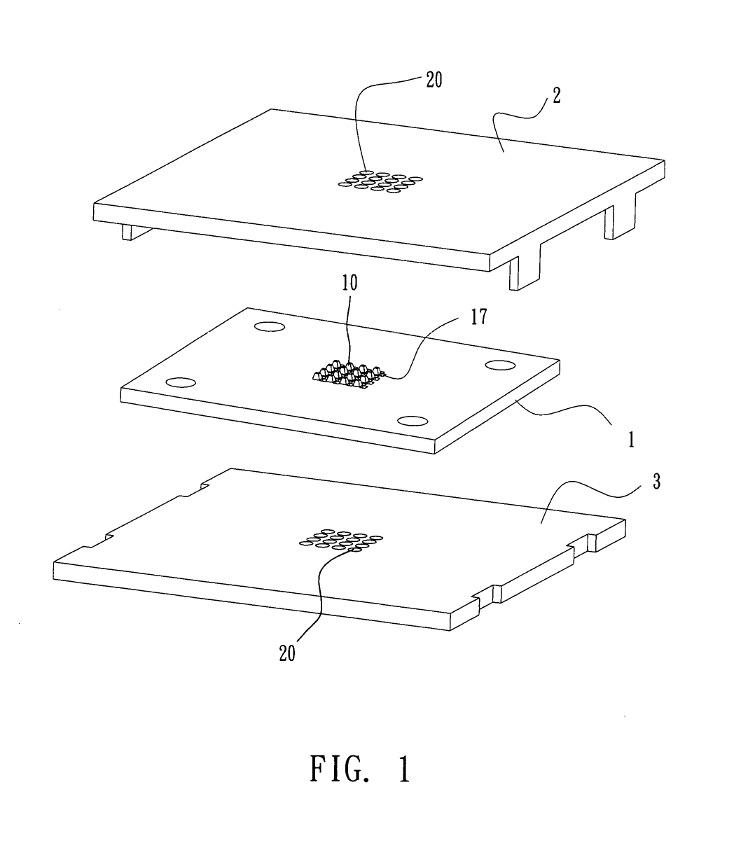

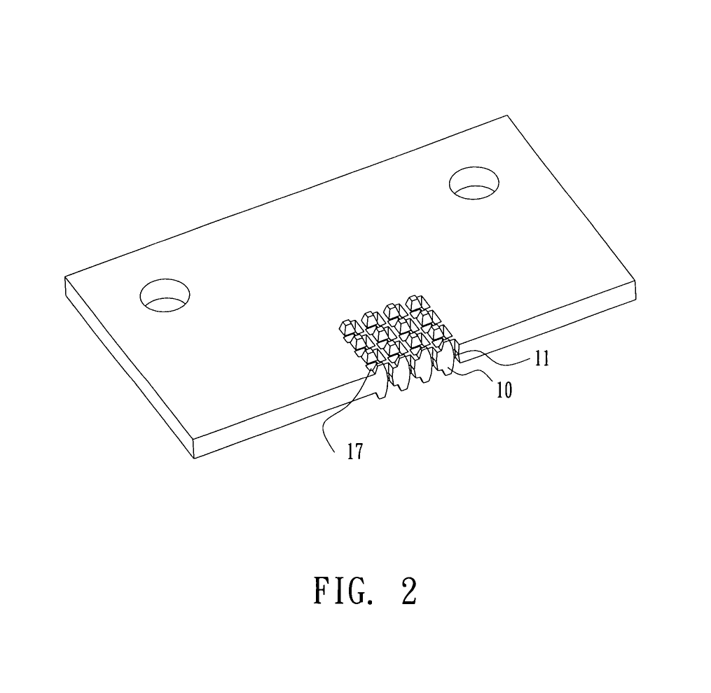

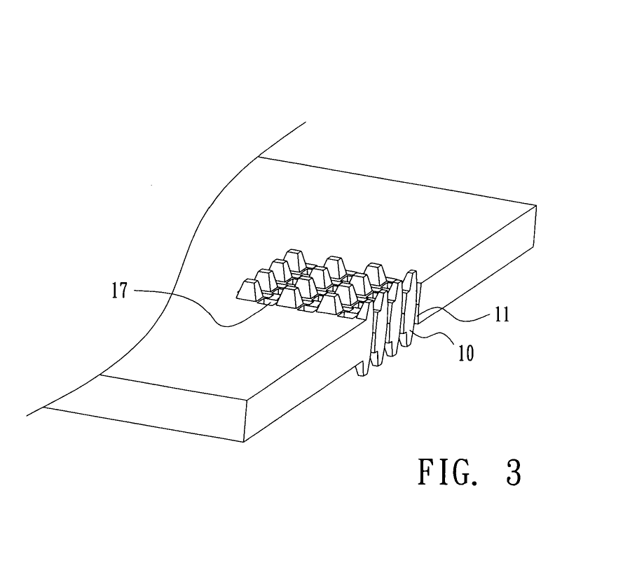

Referring to FIGS. 1 to 3, a preferred embodiment of a manufacturing method for electrical connector according to the present invention comprises the following steps: an insulating body 1 having at least an elastic block 10 is provided and on one side of the elastic block 10 is provided with a through hole 11 and a deformation containing space 17 on the x- and y-axes (step 1); conductive material is applied on the elastic block 10 to form a conductive layer 7 (referring to FIG. 2, step 2).

The detailed procedure of step 2 is described below. A shielding body provided with a penetrating hole 20 (a upper cover 2 and a lower cover 3 with the penetrating hole 20 are presented as an example in the present embodiment; of course, the shielding body can be a sticker), respectively, on a upper cover 2 and a lower cover 3 which are connected together to fixedly locate the insulating body 1 therebetween, such that the elastic block 10 of the insulating body 1 can be aligned with the penetrating hole 20. The physical deposition (sputtering or vapor deposition, for example; of course, other ways of physical deposition can be used as well) to deposit conductive material (for example but not limited to metal, not shown) to form a conductive layer on the elastic block 10, wherein the through hole 11 and the deformation containing space 17 will recede when the insulating body 1 is heated to expand.

Consequently, an electrical connector produced by the manufacturing method for electrical connector according to present method is made entirely of insulating body with the advantages of simple frame and easy manufacturing as well as achieving effective contact between the electrical connector and its connected electronic devices, leading to low manufacturing cost. It indeed overcomes the drawbacks of the conventional prior art of the manufacturing method for electrical connector.

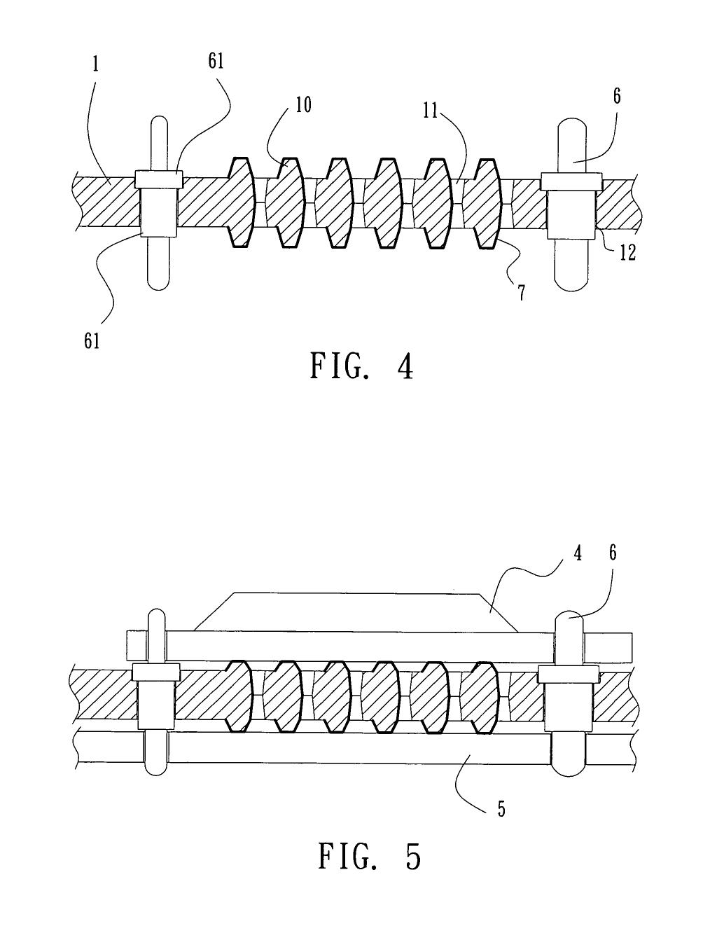

Referring to FIGS. 4 and 5, a preferred embodiment of an electrical connector by the manufacturing method according to the present invention comprising: an insulating body 1; an elastic block 10 (the insulating body 1 is at least provided with an elastic block 10 on its one side; in the present embodiment, one elastic block 10 is provided on both sides, respectively.) provided on one side of the insulating body 1 to contact with connected electronic devices (for example but not limited to, a chip module 4 and a connected circuit 5 in the present embodiment); a through hole 11 provided on one side of the elastic block 10.

Furthermore, the electrical connector further comprises a locating frame 6 and a plurality of deformation containing spaces 17, wherein the locating frame can match with the connected electronic devices (i.e. the chip module 4 and the circuit board 5) and the deformation containing spaces 17 can absorb the expanding deformation of the insulating body 1 and are provided on the x- and y-axes of the electrical connector.

The insulating body 1 and the elastic block 10 are, for example but not limited to, integrally formed. The elastic block 10 is further provided with a conductive layer 7 of, for example but not limited to, metal, which is deposited by physical deposition (sputtering or vapor deposition for example; of course, other ways of physical deposition can be used as well). Four corners of the insulating body 1 are provided with a locating hole 12, respectively, to fixedly locate the locating frame 6 onto the insulating body 1.

The locating frame 6 is further provided with a limit block 61 (the limit block 61, of course, can be placed not on the locating frame 6, but directly on the electrical connector.) to limit the compression height of the connected electronic device 4 so as to prevent the connected electronic devices (i.e. the chip module 4 and the circuit board 5) from over-compressing and thus damaging the electrical connector. When the electronic devices are being connected, the locating frame 6 can compressively contact with the connected electronic devices to achieve the electrical contact of two electronic devices.

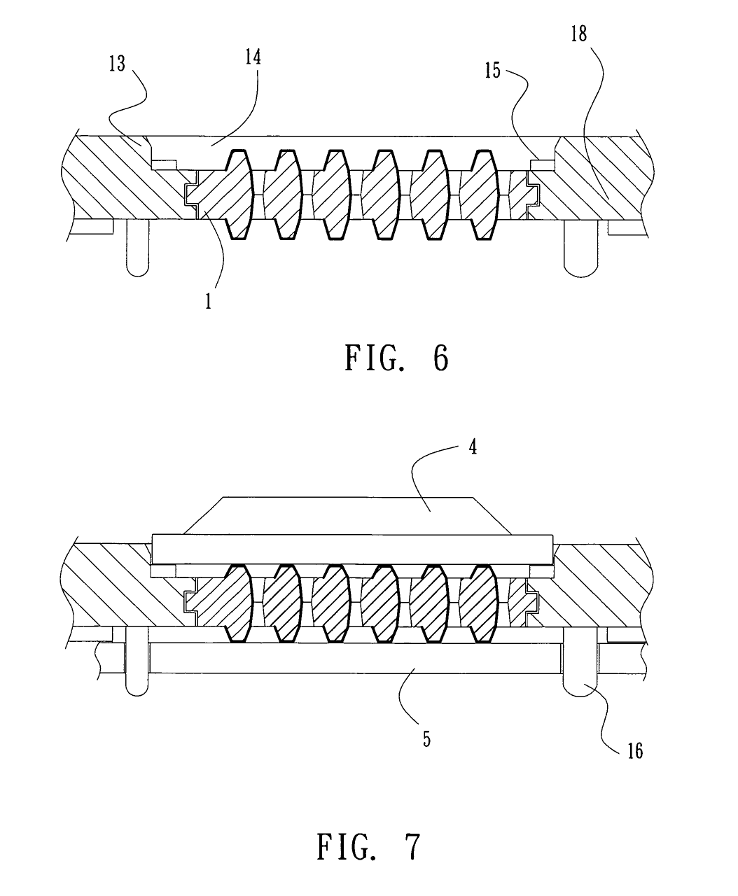

Referring to FIGS. 6 and 7, another embodiment of the electrical connector according to the present invention is illustrated. The difference between the present embodiment with the previous one is described below. The circumference of the insulating body 1 is provided with a locating part 18 for locating the insulating body (the insulating body 1 and the locating part 18 can be integrally formed). The circumference of one side of the locating part 18 is further provided with a location end block 13 to secure the connected electronic device, wherein the locating end block 13 can encompass to form a receiving space 14 for the reception of the chip module 4. The receiving space 14 is further provided with a limit block 15 to prevent the chip module 4 from over-compressing the electrical connector. On the side of the receiving space 14 is provided with a locating rod 6 matched with the circuit board 5 to locate the circuit board 5. The two electronic devices can be electrically connected through the compressively contact with the elastic block 10.

Consequently, by putting the electrical connector and its manufacturing method according to present method into practice, the electrical connector is made entirely of insulating body with the advantages of simple frame and easy manufacturing as well as achieving effective contact between the electrical connector and its connected electronic devices, leading to low manufacturing cost. It indeed overcomes the drawbacks of the conventional prior art of the manufacturing method for electrical connector.

While the invention has been described with reference to the a preferred embodiment thereof, it is to be understood that modifications or variations may be easily made without departing from the spirit of this invention, which is defined by the appended claims.

What is claimed is:

1. A manufacturing method for electrical connector, comprising the following steps:
an insulating body having an elastic block is provided; and
conductive material is applied on the elastic block to form a conductive layer.

2. The manufacturing method for electrical connector as defined in claim 1, wherein the conductive material may be metal.

3. The manufacturing method for electrical connector as defined in claim 1, wherein the conductive layer is applied by physical deposition.

4. The manufacturing method for electrical connector as defined in claim 1, further comprising a shielding body provided with at least a penetrating hole so as to render the elastic block of the electrical connector matched with the penetrating hole and the conductive materials is applied on the elastic block by physical deposition to form a conductive layer.

5. The manufacturing method for electrical connector as defined in claim 4, wherein the shielding body may be a sticker.

6. The manufacturing method for electrical connector as defined in claim 4, wherein the shielding body comprises an upper cover and a lower cover.

7. The manufacturing method for electrical connector as defined in claim 1, wherein the conductive layer is applied by sputtering

8. The manufacturing method for electrical connector as defined in claim 1, wherein the conductive layer is applied by vapor deposition.

9. An electrical connector, comprising:
an insulating body;
at least an elastic block provided on one side of the insulating body to contact with a connected electronic device;
at least a through hole provided on one side of the elastic block; and
a conductive layer provided on the elastic block.

10. The electrical connector as defined in claim 9, wherein the conductive layer is applied on the elastic block by physical deposition, sputtering, or vapor deposition.

11. The electrical connector as defined in claim 9, wherein the other side of the insulating body is correspondingly provided with at least an elastic block.

12. The electrical connector as defined in claim 9, wherein the insulating body and the elastic block is integrally formed.

13. The electrical connector as defined in claim 9, further comprising at least a deformation containing space to contain the expanding deformation of the insulating body.

14. The electrical connector as defined in claim 13, wherein the deformation containing space is provided on the x- and y-axes of the electrical connector.

15. The electrical connector as defined in claim 9, further comprising at least a locating frame matched with a connected electronic device.

16. The electrical connector as defined in claim 15, wherein the electronic device further comprises a chip module and a circuit board.

17. The electrical connector as defined in claim 16, wherein the circumference of the insulating body is further provided with a locating part to locate the insulating body.

18. The electrical connector as defined in claim 17, wherein the circumference of one side of the locating part is provided with a location end block to secure the connected electronic device, and the locating end block can encompass to form a receiving space for the reception of the chip module, wherein the receiving space is further provided with a limit block, and the other side of the locating part is provided with a locating rod to matched with the connected electronic device.

19. The electrical connector as defined in claim 9, wherein the conductive layer may be made of metal.

20. The electrical connector as defined in claim 9, further comprising a shielding body provided with at least a penetrating hole so as to render the elastic block of the electrical connector matched with the penetrating hole and the shielding body may be formed by a sticker or by an upper cover and a lower cover.
